(19) United States
(12) Patent Application Publication
(10) Pub. No.: US 2008/0174528 A1
(43) Pub. Date: Jul. 24, 2008

(54) LIGHT EMITTING DIODE BACK LIGHT SYSTEM AND METHOD FOR DRIVING BACK LIGHT SOURCE USED THEREIN

(75) Inventors: Chi-Hsiu Lin, Yunlin County (TW); Han-Yu Chao, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/758,678

(22) Filed: Jun. 6, 2007

(30) Foreign Application Priority Data
Jan. 24, 2007 (TW) 96102653

(51) Int. Cl. G09G 3/32

(52) U.S. Cl. 345/82

(57) ABSTRACT

A light emitting diode (LED) back light system and a method for driving a back light source used therein are provided. The LED back light system includes an LED back light source, a power converting circuit, and a sequential outputting circuit. The LED back light source includes a plurality of areas. The power converting circuit is used to convert an external power source into a driving power source. The sequential outputting circuit is electrically connected to the power converting circuit and said areas so as to generate a plurality of driving signals according to the driving power source. In addition, said driving signals are sequentially outputted to drive said areas at different time.

### CROSS-REFERENCE TO RELATED APPLICATION

This application claims the priority benefit of Taiwan application serial no. 96102653, filed Jan. 24, 2007. All disclosure of the Taiwan application is incorporated herein by reference.

### BACKGROUND OF THE INVENTION

1. Field of the Invention

The present invention relates to a light emitting diode (LED) back light system and a method for driving an LED back light source. More particularly, the present invention relates to an LED back light system capable of limiting an initial inrush current and a method for driving an LED back light source.

2. Description of Related Art

FIG. 1 shows an architecture of a conventional light emitting diode (LED) back light system. The LED back light system includes a power converting circuit 110, a driving circuit 120, and an LED back light source 130. The power converting circuit 110 is used to receive an external power IN (e.g. an AC 110V/60 Hz power supply) and convert the external power IN into a direct current (DC) driving signal DS, such that the driving circuit 120 drives the LED back light source 130 according to the driving signal DS.

However, with a growing dimension of a panel based on consumers' demands, the required size of the back light system is accordingly increased. The large-sized back light system requires more LEDs to be used, such that higher driving currents are necessary. Thus, the conventional large-sized LED back light systems are mostly driven in a low-voltage, high current mode, which results in an excessive initial inrush current, as shown in FIG. 2.

FIG. 2 shows an input current profile while the LED back light source of FIG. 1 is activated. In in FIG. 2 denotes the input current of the LED back light source 130. Ip represents a peak value of the input current while activation of the LED back light source 130 is initiated. Iss refers to the input current as the LED back light source 130 is activated and stabilized. And T indicates the time during which the input current gradually reaches a steady state, which is called a transient time. It is known from FIG. 2 that the inrush current is instantaneously increased. The high instantaneous current is likely to destroy the devices and force the manufacturers to employ the advanced components, thereby increasing the manufacturing costs and deteriorating electrical selectivity of the devices. Meanwhile, the high instantaneous current also shortens the life time of the LED.

Hence, effectively limiting the initial inrush current without adversely affecting the characteristics of the back light source is important in the panel manufacturing industry.

### SUMMARY OF THE INVENTION

The present invention is directed to a light emitting diode (LED) back light system capable of limiting an initial inrush current.

The present invention is further directed to an LED back light system able to improve electrical selectivity of devices and to reduce the manufacturing costs.

The present invention is further directed to an LED back light system which is likely to extend the life time of the LED.

The present invention is further directed to a method for driving an LED back light source. The method is capable of limiting an initial inrush current.

The present invention is further directed to a method for driving an LED back light source. The method is able to improve electrical selectivity of devices and to reduce the manufacturing costs.

The present invention is further directed to a method for driving an LED back light source. The method is likely to extend the life time of the LED.

The present invention provides an LED back light system. The LED back light system includes an LED back light source, a power converting circuit, and a sequential outputting circuit. The LED back light source includes a plurality of areas. The power converting circuit is used to convert an external power source into a driving power source. The sequential outputting circuit is electrically connected to the power converting circuit and said areas so as to generate a plurality of driving signals according to the driving power source. Moreover, said driving signals are sequentially outputted to drive said areas at different time.

The present invention further provides a method for driving an LED back light source. The method includes dividing the LED back light source into a plurality of areas at first and then converting an external power source to a driving power source. Thereafter, a plurality of driving signals is generated according to the driving power source, and the driving signals are sequentially outputted so as to drive said areas at different time.

According to one embodiment of the present invention, the LED back light system further includes a plurality of driving circuits which are electrically connected to the sequential outputting circuit and to said areas, respectively. Each of the driving circuits drives one of the areas based on one of the driving signals.

According to one embodiment of the present invention, each of the driving signals is used to drive one of the areas.

According to one embodiment of the present invention, the external power source is an alternating current source, while the driving power source is a direct current source.

In the present invention, the back light source is divided into the plurality of areas which are sequentially driven. Thus, the initial inrush current is averaged, and thereby the initial inrush current of the back light system is limited. On the other hand, the present invention can also improve electrical selectivity of the devices, reduce the manufacturing costs, and extend the life time of the LED.

In order to the make the aforementioned and other objects, features and advantages of the present invention comprehensible, several embodiments accompanied with figures are described in detail below.

### BRIEF DESCRIPTION OF THE DRAWINGS

FIG. 1 is a block diagram depicting an architecture of a conventional light emitting diode (LED) back light system.

FIG. 2 is a diagram depicting an input current profile while the LED back light source of FIG. 1 is activated.

FIG. 3 is a block diagram depicting an architecture of an LED back light system according to one embodiment of the present invention.

FIG. 4 is a diagram depicting a process of driving an LED back light source according to one embodiment of the present invention.

FIG. 5 is a diagram depicting an input current profile while the LED back light source of FIG. 3 is activated.

FIG. 6 is a block diagram depicting an architecture of an LED back light system according to another embodiment of the present invention.

### DESCRIPTION OF EMBODIMENTS

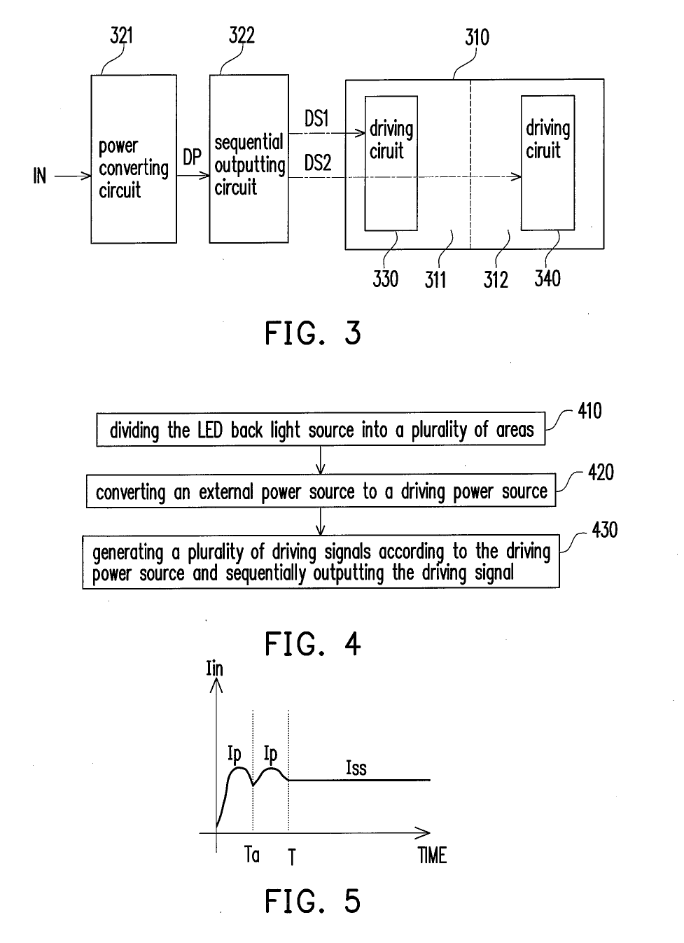

FIG. 3 shows an architecture of a light emitting diode (LED) back light system according to one embodiment of the present invention. FIG. 4 shows a process of driving an LED back light source according to one embodiment of the present invention. Please refer to FIGS. 3 and 4 together with the description if deemed necessary. The LED back light system illustrated in FIG. 3 includes an LED back light source 310, a power converting circuit 321, a sequential outputting circuit 322, and driving circuits 330 and 340. The LED back light source 310 has a first area 311 and a second area 312 which result from dividing the LED back light source into a plurality of areas in step 410 as shown in FIG. 4.

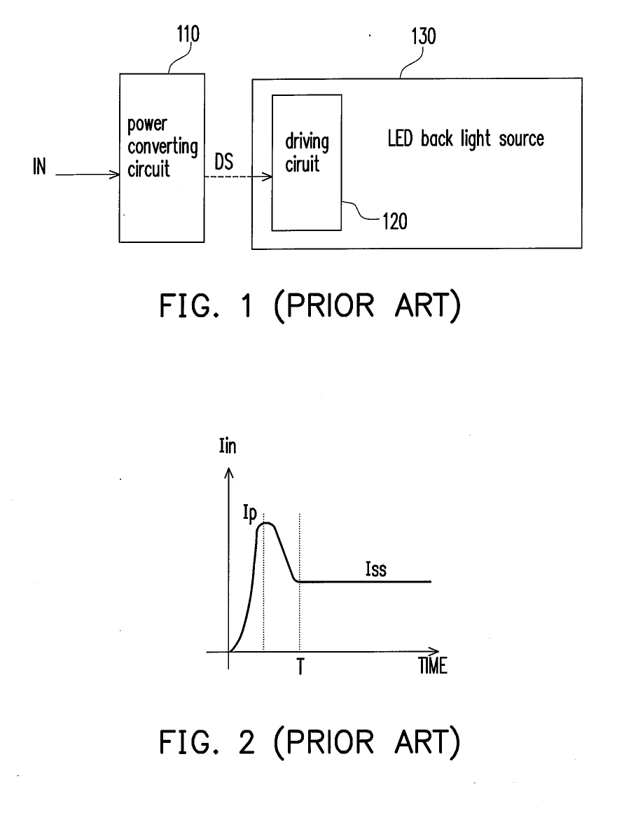

To facilitate the following description, the LED back light source 310 is assumed to be composed of a plurality of LEDs, and the number of the LEDs in the first area 311 is identical to that in the second area 312. Moreover, the LED back light source 310 of FIG. 3 and the LED back light source 130 of FIG. 1 are predetermined to have the same dimension.

The power converting circuit 321 is used to convert an external power IN into a driving power source DP. In other words, an alternating current (AC) source is converted to a direct current (DC) source to reach a voltage level required by the driving circuits 330 and 340. The sequential outputting circuit 322 is electrically connected to the power converting circuit 321 for generating driving signals DS1 and DS2 based on the driving power source DP. Furthermore, the driving signals DS1 and DS2 are sequentially outputted so as to drive the first area 311 and the second area 312 at different time.

The driving circuits 330 and 340 merely drive half of the LED back light source 310, and therefore an initial inrush current is averaged as shown in FIG. 5. FIG. 5 shows an input current profile while the LED back light source of FIG. 3 is activated. Iin in FIG. 5 denotes the input current of the LED back light source 310. Ip represents a peak value of the input current while activation of the LED back light source 310 is initiated. Iss refers to the input current as the LED back light source 310 is activated and stabilized. Ta indicates a time difference between the time at which the driving circuit 330 is activated and the time at which the driving circuit 340 is about to be activated. And T stands for the time during which the input current gradually reaches a steady state, which is called a transient time. By comparing the profiles illustrated in FIGS. 1 and 2, it can be understood that the inrush current in FIG. 2 is much less than that in FIG. 1. Specifically, the peak value Ip of the input inrush current in FIG. 2 is half of the peak value Ip of the input inrush current in FIG. 1.

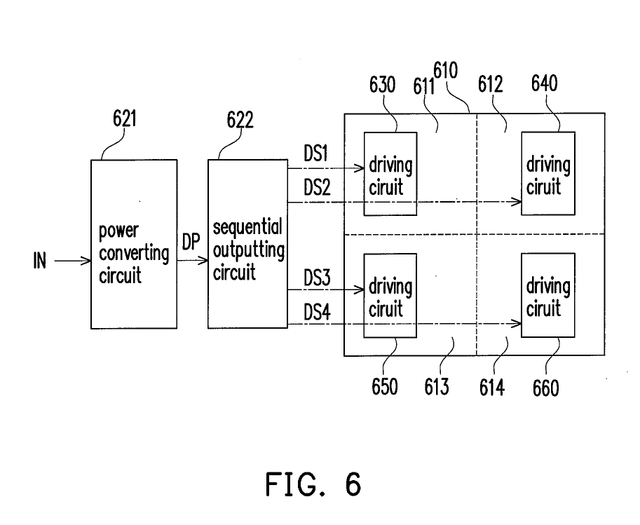

It should be noted that although a possible mode of the present invention is already demonstrated in the above embodiment, people skilled in the art should know that the inrush current may be farther limited by dividing the LED back light source into more areas which are sequentially driven. The present invention is farther exemplified by dividing the LED back light source into four areas for further elaboration and implementation, as shown in FIG. 6.

FIG. 6 shows an architecture of an LED back light system according to another embodiment of the present invention. Please refer to FIG. 6. The LED back light system illustrated in FIG. 6 includes an LED back light source 610, a power converting circuit 621, a sequential outputting circuit 622, and driving circuits 630, 640, 650 and 660. The LED back light source 610 has a first area 611, a second area 612, a third area 613, and a fourth area 614.

To facilitate the following description, the LED back light source 610 is assumed to be composed of a plurality of LEDs, and the numbers of the LEDs in the first area 611, the second area 612, the third area 613 and the fourth area 614 are identical. Moreover, the LED back light source 610 of FIG. 6 and the LED back light source 130 of FIG. 1 are predetermined to have the same dimension.

The power converting circuit 620 is used to convert an external power IN into a driving power source DP. The sequential outputting circuit 622 is electrically connected to the power converting circuit 621 for generating driving signals DS1, DS2, DS3 and DS4 based on the driving power source DP. Furthermore, the driving signals DS1, DS2, DS3 and DS4 are sequentially outputted so as to drive the first area 611, the second area 612, the third area 613 and the fourth area 614 at different time.

The driving circuits 630, 640, 650 and 660 merely drive a quarter of the LED back light source 610. Therefore, in compare with the back light system of FIG. 3, an initial inrush current in the present embodiment is only half of the initial inrush current in FIG. 3.

According to the above embodiments, the LED back light source is divided into the plurality of areas, and the numbers of the LEDs in each of the areas are identical. Nevertheless, it is obvious for people skilled in the art that the present invention can be implemented as well even though the numbers of the LEDs in each of the areas are different.

In view of the foregoing, the LED back light source is divided into the plurality of areas which are sequentially driven in the present invention. Thus, the initial inrush current is averaged, and thereby the initial inrush current of the back light system is limited. On the other hand, the present invention can also improve electrical selectivity of the devices, reduce the manufacturing costs, and extend the life time of the LED.

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A light emitting diode (LED) back light system, comprising:
an LED back light source comprising a plurality of areas;
a power converting circuit used to convert an external power source into a driving power source; and
a sequential outputting circuit electrically connected to the power converting circuit and said areas so as to generate a plurality of driving signals according to the driving power source, said driving signals being sequentially outputted to drive said areas at different time.

2. The LED back light system of claim 1, further comprising:
a plurality of driving circuits electrically connected to the sequential outputting circuit and to said areas, respectively, wherein each of the driving circuits drives one of the areas according to one of the driving signals.

3. The LED back light system of claim 1, wherein the external power source is an alternating current source, while the driving power source is a direct current source.

4. The LED back light system of claim 1, wherein each of the areas comprises at least an LED.

5. The LED back light system of claim 4, wherein the numbers of the LEDs in each of the areas are identical.

6. A method for driving a light emitting diode (LED) back light source, comprising:
dividing the LED back light source into a plurality of areas;
converting an external power source to a driving power source; and
generating a plurality of driving signals according to the driving power source and sequentially outputting the driving signals so as to drive said areas at different time.

7. The method for driving the LED back light source of claim 6, wherein each of the driving signals is used to drive one of the areas.

8. The method for driving the LED back light source of claim 6, wherein the external power source is an alternating current source, while the driving power source is a direct current source.

9. The method for driving the LED back light source of claim 6, wherein each of the areas comprises at least an LED.

10. The method for driving the LED back light source of claim 9, wherein the numbers of the LEDs in each of the areas are identical.
